(19) United States
(12) Patent Application Publication
(10) Pub. No.: US 2006/0083007 A1
(43) Pub. Date: Apr. 20, 2006

(54) Wall mount with detachable support panel

(76) Inventors: Eric J. Haugaard, Kenosha, WI (US); Kurt S. Wilcox, Libertyville, IL (US)

Correspondence Address: JANSSON, SHUPE, MUNGER & ANTARAMIAN, LTD, 245 MAIN STREET, RACINE, WI, 53403, US

(21) Appl. No.: 10/966,878

(22) Filed: Oct. 15, 2004

(51) Int. Cl. F21V 19/00

(52) U.S. Cl. 362/382

(57) ABSTRACT

An apparatus for mounting a lighting fixture is provided having a mount housing with at least one pivot portion and a support panel with at least one hook portion, the support panel being attached to the mount housing in a manner where the hook portion can slide and pivot with respect to the pivot portion. The pivot portion includes a rail, a tab-slot and a tab-rest, the tab-slot and tab-rest being adjacent to the rail and the hook portion has a hook member and a tab-stand adjacent to the hook member. The support panel is free to move between an open and a closed position and, preferably, detachable from the mount housing. A method for mounting a lighting fixture is also disclosed.

### FIELD OF THE INVENTION

This invention is related generally to apparatus for mounting lighting fixtures and, more particularly, to apparatus for mounting lighting fixtures having a slidable and pivotable support panel.

### BACKGROUND OF THE INVENTION

A wide variety of flood and area lighting fixtures exist to provide illumination of buildings, parking lots, walkways and the like. Such fixtures are frequently mounted high in the air on the walls of buildings where they can only be installed with the assistance of a ladder or aerial lift. Of particular concern, however, is that most lighting fixtures of this type are unwieldy in size, shape and weight, making them extremely difficult to handle when installed. These fixtures also often use mounting brackets that are either unattractive or clash with the appearance of the lighting fixture or its surrounding building.

Installation of a flood or area lighting fixture requires that it first be properly connected electrically to the wiring needed to power the fixture before it is mechanically fastened to the supporting wall mount. Both of these operations can be dangerous, however, when the installation is performed high above the ground from oftentimes only the top of a ladder. Since either operation demands the use of two hands, the installer must find a way to support the fixture upon the ladder near him and yet leave unobstructed the needed workspace. As a result, given the dimensions and weight of the lighting fixture, installation is usually accomplished in a manner contributing undue risk to the worker.

It would be highly desirable therefore to have a mounting apparatus that first fastens the lighting fixture to the apparatus in an easy and efficient manner and afterwards elevates the fixture such that it is above yet adjacent to the workspace needed by the installer for completing the remaining electrical connections. This invention meets these needs and overcomes other problems and shortcomings found in the prior art.

### OBJECTS OF THE INVENTION

An object of this invention is to provide an improved apparatus for mounting a lighting fixture that overcomes a number of the problems and shortcomings in the prior art, including those referred to above.

Another object of the invention is to provide a novel apparatus for mounting a lighting fixture that allows the fixture to be mechanically secured to the apparatus in a convenient manner before having to perform any electrical connections to the fixture.

Another object of the invention is to provide an exceptional apparatus for mounting a lighting fixture having a support panel that permits the fixture to be maintained in an elevated position so as to facilitate making electrical connections during installation of the fixture as well as to provide convenient access to such connections afterwards.

Yet another object of the invention is to provide an excellent apparatus for mounting a lighting fixture having a support panel that is detachable from its mount housing to allow for safe and efficient securing of the fixture to the panel and to permit unobstructed access within the housing to the leads of the electrical conduit needed to power the fixture.

Still another object of the invention is to provide a desirable apparatus for mounting a lighting fixture that is simple and inexpensive to construct, highly reliable to use and pleasing in appearance.

### SUMMARY OF THE INVENTION

This invention is an improved apparatus for mounting a lighting fixture. The apparatus has a mount housing with at least one pivot portion and a support panel with at least one hook portion, the support panel being attached to the mount housing in a manner where the hook portion can slide and pivot with respect to the pivot portion. The pivot portion includes a rail, a tab-slot and a tab-rest, the tab-slot and tab-rest being adjacent to the rail. The hook portion has a hook member and a tab-stand adjacent to the hook member. The support panel is free to move between an open and a closed position.

In certain desired embodiments, the hook portion is detachably engaged with respect to the pivot portion to allow the support panel to be removed and then reattached to the mount housing. More desirable is where the mount housing has two pivot portions and the support panel has two corresponding hook portions. A highly preferred embodiment finds the pivot portion also having a tab-stop located between the tab-slot and the tab-rest.

Also preferred is where the apparatus includes a front-wall and where the mount housing has two front-wall portions. The front-wall portion define a support-panel cavity that allows the mount housing to fittingly engage the support panel when it is in the closed position so that the front-wall portions and the support panel form the front-wall.

In a most desirable embodiment, the mount housing has at least one entry-site that serves to allow an electrical conduit to be inserted into the apparatus. The term “entry-site” as used herein refers to a structure formed within the apparatus that is adapted to allow an electrical conduit or other electrical wiring to be inserted or otherwise received by the apparatus. Such structures include enclosed apertures, not fully enclosed apertures and knockouts where the aperture is covered with a breakaway wall.

Most desirable is where the mount housing comprises a wall bracket and a housing cover that is removably secured to the wall bracket. Also preferred is where the mount housing has top, rear and side entry-sites. A wall bracket that has attachment-slots so that the mount housing can be secured to a junction box is highly desirable.

Another aspect of this invention provides an apparatus for mounting a lighting fixture that includes a wall bracket with at least one entry-site adapted to receive an electrical conduit, a housing cover that can be secured to but later taken off the wall bracket, the housing cover having a cover-site that is aligned with the entry-site, and a support panel that is slidably and pivotally engaged to the housing cover. Preferably, the wall bracket has attachment-slots to allow the apparatus to be secured to a junction box.

In this aspect of the invention, a desirable embodiment is where the housing cover has two front-wall portions that together define a support-panel cavity. The cavity is sized to fittingly receive the support panel such that in the closed position, the support panel and the front-wall portions complete a front-wall to the apparatus.

More preferred is where the housing cover has a pivot portion and the support panel has a hook portion. The pivot portion includes a rail along with a tab-slot and a tab-rest adjacent to the rail. The hook portion includes a hook member and a tab-stand adjacent to the hook member. Moreover, the hook portion is slidably and pivotally engaged to the pivot portion. In a most desirable embodiment, the hook portion is also detachable from the pivot portion on which it slides and pivots.

In another aspect of this invention, a method is provided for mounting a lighting fixture to a selected surface. This method includes the steps of (1) providing a mounting apparatus having a mount housing and a support panel slidably and pivotally engaged to the mount housing that allows the support panel to freely move between open and closed positions; (2) attaching the mount housing to the selected surface at a desired position; (3) inserting electrical wiring into the mount housing; (4) securing the lighting fixture to the support panel; (5) moving the support panel to its open position; (6) connecting the electrical wiring to the lighting fixture; and (7) moving the support panel to the closed position.

Certain embodiments of this method find the support panel to be detachable from the mount housing and adding the steps of detaching the support panel from the mount housing and of attaching the support panel to the mount housing after securing the lighting fixture to the panel.

Most desirable is where the mount housing includes two pivot portions, each having a rail, a tab-slot and a tab-rest, and the support panel includes hook portions, each having a hook member and a tab-stand. Each hook portion is furthermore slidably and pivotally engaged with respect to a corresponding pivot portion.

In a preferred embodiment of this method, the mount housing includes a wall bracket and a housing cover removably secured to the wall bracket. More preferred is where the mount housing has top, rear and side entry-sites through which an electrical conduit can be inserted. Highly preferred finds the desired position to be adjacent to a junction box.

Another aspect of this invention is directed to an apparatus for mounting a lighting fixture that has a mount housing and a support panel secured with respect to the lighting fixture. The mount housing includes a pivot portion and the support panel a hook portion, the hook portion being slidably and pivotally engaged with respect to the pivot portion. Preferably, the pivot portion comprises a rail, a tab-slot and a tab-rest, the tab-slot and tab-rest being adjacent to the rail, and the hook portion comprises a hook member and a tab-stand adjacent to the hook member.

In certain select embodiments, the apparatus also has a front-wall such that the two front-wall portions of the mount housing and the support panel complete the front-wall. Highly desirable is where the hook portion of the support panel is detachably engaged with the pivot portion of the mount housing.

### BRIEF DESCRIPTION OF THE DRAWINGS

FIG. 1 is an exploded view of a preferred apparatus for mounting a lighting fixture in accordance with this invention.

FIG. 2 is a rear view of a preferred support panel of the apparatus of FIG. 1.

FIG. 3A is a front view of a preferred housing cover of the apparatus of FIG. 1.

FIG. 3B is a rear view of the housing cover of FIG. 3A.

FIG. 4 is a perspective view of the apparatus in the open position with an attached lighting fixture.

FIG. 5 is a perspective view of the apparatus in the closed position with an attached lighting fixture.

### DETAILED DESCRIPTION OF PREFERRED EMBODIMENTS

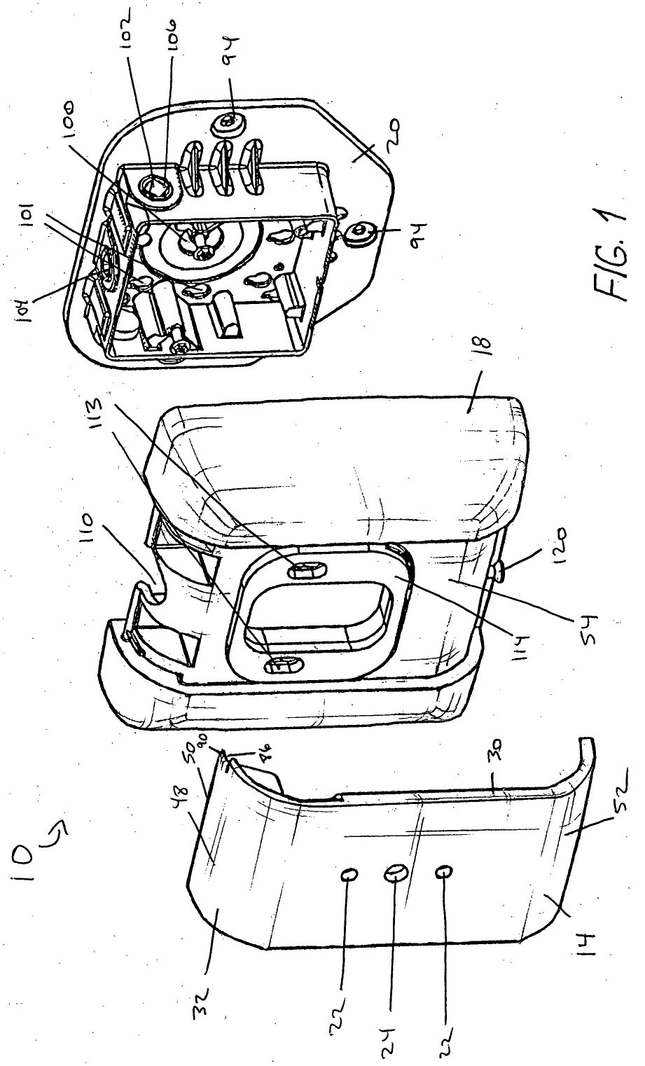

The drawings illustrate an improved apparatus 10 for mounting a lighting fixture 12 in accordance with this invention. Apparatus 10 includes support panel 14 and mount housing 16. As seen in the preferred embodiment shown in FIG. 1, mount housing 16 has housing cover 18 and wall bracket 20.

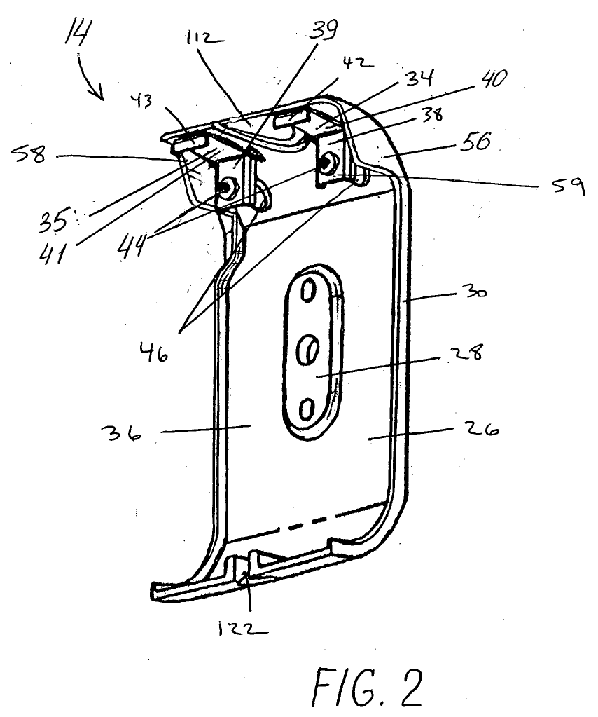

Support panel 14 is provided with two support apertures 22 and wiring aperture 24. When mounted, lighting fixture 12 is rigidly secured to support panel 14 by having two fasteners (not shown) received in each support aperture 22 from the rear wall of lighting fixture 12. The fasteners are preferably ⅝ inch bolts having a diameter appropriate for the size and weight of the fixture being mounted. As illustrated in FIG. 2, rear surface 26 of support panel 14 has reinforced portion 28 surrounding apertures 22, 24, adding depth to panel wall 30, to insure a firm engagement between fixture 12 and front surface 32 when securing the bolts in place with corresponding nuts (not shown).

As seen in FIG. 2, support panel 14 includes two hook members 34, 35 mounted to panel base 36. Each hook member 34, 35 is preferably a single piece of sheet metal of sufficient gauge to provide structural integrity but still allow hook members 34, 35 to receive two bends so as to form mounting portions 38, 39, middle portions 40, 41 and hooks 42, 43. Hook fastener 44 is received by mounting boss 46 to secure mounting portions 38, 39 to panel base 36. Middle portions 40, 41 extend rearward from mounting portions 38, 39 and upward at an angle corresponding to the curve of upper end 48. The distal end of each mounting portion 38, 39 is adjacent to upper edge 50 of panel base 36. Hooks 42, 43 extend downward from the distal end of the corresponding middle portion 40, 41 and are parallel with the corresponding mounting portion 38, 39. Panel base 36 is preferably fabricated from a strong lightweight metal such as die-cast aluminum. Upper and lower ends 48, 52 of panel base 36 curve rearward to permit support panel 14 to fittingly engage the arcuately curved front surface 54 of housing cover 18.

Upper end 48 of panel base 36 forms first and second tab-stands 56, 58 at both ends of upper edge 50. Tab-stands 56, 58 are parallel with each other and orthogonal to upper edge 50. Tab-stands 56, 58 together with hook members 34, 35 comprise hook portion 59 of support panel 14.

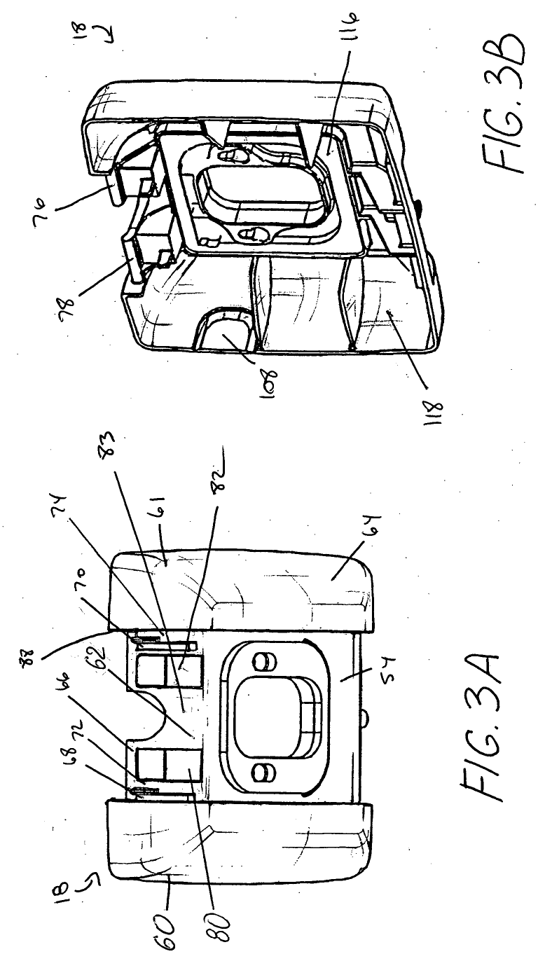

Housing cover 18 is also preferably fabricated from die-cast aluminum. As shown in FIG. 3, housing cover 18 forms first and second front-wall portions 60, 61 on either side of support-panel cavity 62. Support-panel cavity 62 is recessed below the outer surface 64 of front-wall portion 60, 61. Top end 66 of support-panel cavity 62 forms first and second tab-slots 68, 70; first and second tab-rests 72, 74; first and second rails 76, 78; and first and second receptacle spaces 80, 82. Tab-slots 68, 70, tab-rests 72, 74, and rails 76, 78 comprise pivot portion 83 of mount housing 16.

In attaching support panel 14 to housing cover 18, hooks 42, 43 are placed behind corresponding rail 76, 78. Hook members 34, 35 engage rails 76, 78 in a manner that allows hook members 34, 35 and thereby support panel 14 to slide laterally and pivot upward upon housing cover 18. When attached, hooks 42, 43 serve as stops that prevents support panel 14 from slipping off rails 76, 78. Support panel 14 can, however, be easily detached from housing cover 18 by lifting support panel 14 upward until hooks 42, 43 are clear of rails 76, 78.

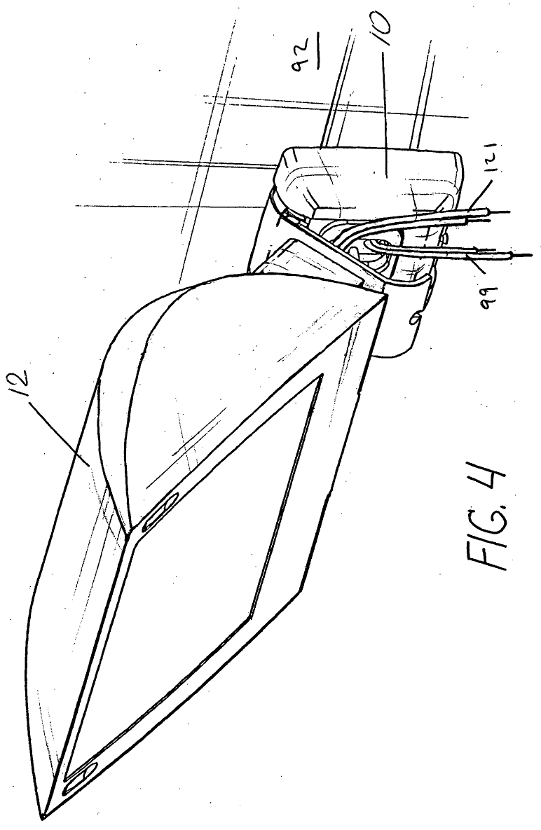

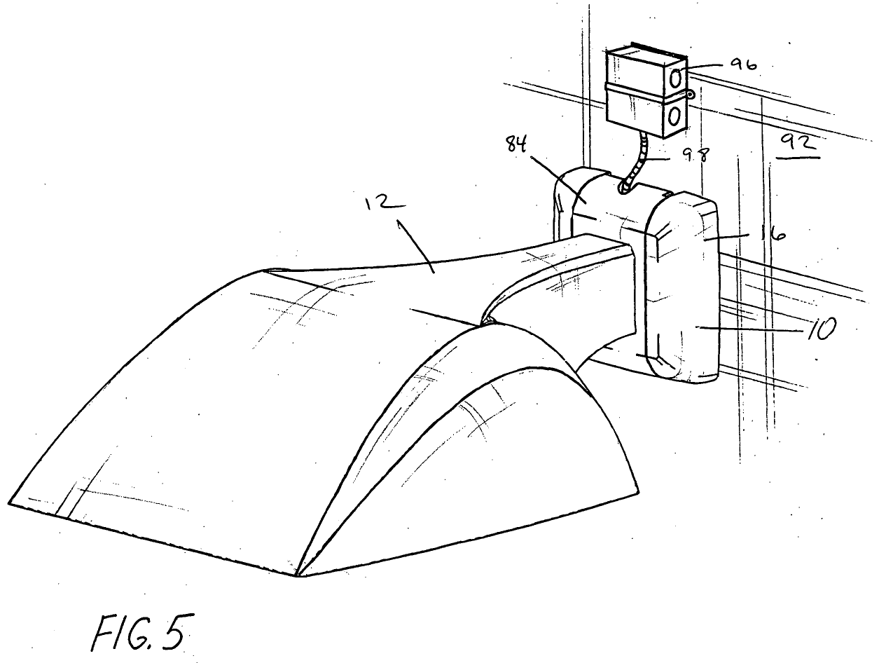

When attached to housing cover 18, support panel 14 can be moved to either an open or closed position as illustrated in FIGS. 4-5. Support panel 14 is placed in the closed position by sliding it along rails 76, 78 to where first and second tab-stands 56, 58 align with first and second tab-slots 68, 70 respectively. Tab-stands 56, 58 are received by tab-slots 68, 70 and hook members 34, 35 are received by the corresponding receptacle space 80, 82 to place support panel 14 in fitted engagement within support-panel cavity 62. In the closed position, front surface 32 of support panel 14 form with outer surface 64 of front-wall portions 60, 61 a contiguous front-wall 84 for housing cover 18.

Support panel 14 is placed in the open position from the closed position by pivoting support panel 14 upward until tab-stands 56, 58 clear tab-slots 68, 70. Support panel 14 can then be slide laterally along rails 76, 78 until tab-stands 56, 58 are in alignment with corresponding tab-rests 72, 74. One can readily see that tab-stands 56, 58 allow support panel 14 to be supported in an elevated, open position by abutting and resting upon tab-rests 72, 74.

Panel notch 86 in upper edge 50 of support panel 14 serves to limit lateral movement of support panel 14 by allowing support panel 14 to slide past the sidewall 88 of second front-wall portion 61 until stopped by notch edge 90. Panel notch 86 prevents support panel 14 from being slid inadvertently to a position where tab-stands 56, 57 could drop into receptacle spaces 80, 82. Tab stops 92 are situated between each tab slot 68, 70 and tab-rests 72, 74 to likewise prevent support panel 14 from inadvertently sliding towards first front-wall portion 60 while in the open position such that tab-stands 56, 57 drop into tab-slots 68, 70. Support panel 14 must be pivoted back and slid over tab-rests 72, 74 for support panel 14 to be returned to its closed position.

In mounting fixture 12 to a selected surface such as a wall 92 as shown in FIGS. 4-5, wall bracket 20 is mounted to wall 92 using the appropriate fasteners for the surface and location, fasteners being received by bracket apertures 94. Wall bracket 20 is preferably placed adjacent to a junction box 96. Electrical conduit 98 can be inserted into wall bracket 20 directly as seen in FIG. 5 or electrical leads 99 from a junction box recessed in the wall as seen in FIG. 4 can be received through rear entry aperture 100. Attachment-slots 101 are provided for mounting wall bracket 20 over such recessed junction boxes.

Wall bracket 20 is provided with a number of entry-sites 102 in addition to rear entry aperture 100. Top and side entry-sites 104, 106 are preferably knockouts for use as needed. Housing cover 18 has side cover-sites or knockouts 108 aligned with the corresponding entry-site on wall bracket 20 for use as needed. Slotted aperture 110 along top end 66 of housing cover 18 is a top cover-site and is aligned with top entry-site 104 on wall bracket 20. Top knockout 112 along upper edge 50 of support panel 14 is likewise used only when needed to insert electrical conduit 98 through slotted aperture 110 and top entry-site 104 into wall bracket 20.

Housing cover 18 is provided with lateral slots 113 to receive fasteners to align and attach housing cover 18 to wall bracket 20. First and second gaskets 114, 116 are mounted on front surface 54 and rear surface 118 of housing cover 18. Gaskets 114, 116 are preferably made from neoprene and served to create a water-tight seal around electrical wiring within apparatus 10. A gasket of similar material (not shown) is also mounted on the real wall of wall bracket 20.

In the open position as illustrated in FIG. 4, electrical wiring 121 for the electrical components and lamp of fixture 12 are received through wiring aperture 24 of support panel 14. Fixture 12, being rigidly mounted upon support panel 14, stays in place and out of the way, elevated above the work space where electrical leads 99 serving as the source of power for fixture 12 and electrical wiring 121 are present. Both of the installer's hands are therefore free to safely make the necessary connections between electrical wiring 121 and electrical leads 99.

After the connections are completed, support panel 14 with fixture 12 can easily and quickly be slid over toward first front-wall portion 60 to allow support panel 14 to pivot completely downward into the closed position. In that position, locking fastener 120 on housing cover 16 is received by locking slot 122 in lower end 52 of support panel 14. By screwing down locking fastener 120, support panel 14 is secured to housing cover 16, giving apparatus 10 a pleasing and integrated appearance.

Although the invention has been described in conjunction with specific embodiments thereof, it is evident that many alterations, modification and variations will be apparent to those skilled in the art. Accordingly, it is intended to embrace all such alternatives, modifications and variations that fall within the spirit and broad scope of the appended claims.

1. An apparatus for mounting a lighting fixture comprising:
a mount housing having at least one pivot portion, the pivot portion including a rail, a tab-slot and a tab-rest, the tab-slot and tab-rest being adjacent to the rail; and
a support panel having at least one hook portion, the hook portion including a hook member and a tab-stand adjacent to the hook member and being slidably and pivotally engaged with respect to the pivot portion, whereby the support panel is free to move between open and closed positions.

2. The apparatus of claim 1 wherein the hook portion is detachably engaged with respect to the pivot portion.

3. The apparatus of claim 2 wherein the mount housing has two pivot portions and the support panel has two corresponding hook portions.

4. The apparatus of claim 2 wherein the pivot portion includes a tab-stop positioned between the tab-slot and the tab-rest.

5. The apparatus of claim 1 further comprising a front-wall and wherein the mount housing has two front-wall portions defining a support-panel cavity sized to fittingly receive the support panel in the closed position, whereby the front-wall portions together with the support panel complete the front-wall.

6. The apparatus of claim 1 wherein the mount housing has at least one entry-site, whereby an electrical conduit can be inserted into the apparatus through the entry-site.

7. The apparatus of claim 6 wherein the mount housing comprises a wall bracket and a housing cover removably secured to the wall bracket.

8. The apparatus of claim 7 wherein the mount housing has top, rear and side entry-sites.

9. The apparatus of claim 8 wherein the wall bracket has attachment-slots, whereby the mount housing can be secured to a junction box.

10. An apparatus for mounting a lighting fixture comprising:
a wall bracket having at least one entry-site adapted to receive an electrical conduit;
a housing cover removably secured to the wall bracket and having a cover-site aligned with the entry-site; and
a support panel slidably and pivotally engaged with respect to the housing cover, the support panel being free to move between open and closed positions.

11. The apparatus of claim 10 further comprising a front-wall and wherein the housing cover has two front-wall portions defining a support-panel cavity sized to fittingly receive the support panel in the closed position, whereby the front-wall portions together with the support panel complete the front-wall.

12. The apparatus of claim 11 wherein the housing cover has at least one pivot portion, the pivot portion including a rail, a tab-slot and a tab-rest, the tab-slot and tab-rest being adjacent to the rail, and the support panel has at least one hook portion, the hook portion including a hook member and a tab-stand adjacent to the hook member, whereby the hook portion is slidably and pivotally engaged with respect to the pivot portion.

13. The apparatus of claim 12 wherein the hook portion is detachably engaged with respect to the pivot portion.

14. The apparatus of claim 13 wherein the wall bracket has attachment-slots, whereby the apparatus can be secured to a junction box.

15. A method for mounting a lighting fixture to a selected surface comprising:
providing a mounting apparatus having a mount housing and a support panel slidably and pivotally engaged with respect to the mount housing such that the support panel is free to move between open and closed positions;
attaching the mount housing to the selected surface at a desired position;
inserting electrical wiring into the mount housing;
securing the lighting fixture to the support panel;
moving the support panel to the open position;
connecting the electrical wiring with respect to the lighting fixture; and
moving the support panel to the closed position.

16. The method of claim 15 wherein the support panel is detachably engaged to the mount housing and further comprising the step of detaching the support panel from the mount housing and the step of attaching the support panel to the mount housing following the securing step.

17. The method of claim 16 wherein the mount housing has two pivot portions, each of the pivot portions including a rail, a tab-slot and a tab-rest, the tab-slot and tab-rest being adjacent to the rail, and the support panel has two corresponding hook portions, each of the hook portions including a hook member and a tab-stand adjacent to the hook member, whereby each hook portion is slidably and pivotally engaged with respect to the corresponding pivot portion.

18. The method of claim 17 wherein the mount housing comprises a wall bracket and a housing cover removably secured to the wall bracket.

19. The method of claim 18 wherein the mount housing has top, rear and side entry-sites through which an electrical conduit may be inserted.

20. The method of claim 19 wherein the desired position is adjacent to a junction box.

21. An apparatus for mounting a lighting fixture comprising:
a mount housing having at least one pivot portion; and
a support panel secured with respect to the lighting fixture, the support panel having at least one hook portion, the hook portion being slidably and pivotally engaged with respect to the pivot portion, whereby the support panel is free to raise and lower the lighting fixture.

22. The apparatus of claim 21 further comprising a front-wall and wherein the mount housing has two front-wall portions defining a support-panel cavity sized to fittingly receive the support panel in the closed position, whereby the front-wall portions together with the support panel complete the front-wall.

23. The apparatus of claim 21 wherein the pivot portion includes a rail, a tab-slot and a tab-rest, the tab-slot and tab-rest being adjacent to the rail, and the hook portion includes a hook member and a tab-stand adjacent to the hook member.

24. The apparatus of claim 21 wherein the hook portion is detachably engaged with respect to the pivot portion.
